(19) United States
(12) Patent Application Publication
(10) Pub. No.: US 2014/0292637 A1
(43) Pub. Date: Oct. 2, 2014

(54) METHOD FOR ADJUSTING HEAD-MOUNTED DISPLAY ADAPTIVELY AND HEAD-MOUNTED DISPLAY

(71) Applicant: Altek Semiconductor Corp., Hsinchu City (TW)

(72) Inventors: Shih-Yuan Peng, New Taipei City (TW); Chen-Hsuan Tai, Hsinchu County (TW)

(73) Assignee: Altek Semiconductor Corp., Hsinchu City (TW)

(21) Appl. No.: 13/895,380

(22) Filed: May 16, 2013

(30) Foreign Application Priority Data
Mar. 27, 2013 (TW) 102110950

(51) Int. Cl. G02B 27/01; G02B 27/00

(52) U.S. Cl. CPC G02B 27/0172; G02B 27/0093
USPC 345/156

(57) ABSTRACT

A method for adjusting head mounted display adaptively and a head mounted display are provided. The method includes the following steps. Eye state parameters of a user wearing the head-mounted display are sensed by using a first sensing unit, and whether the user's eyes are discomfort or not is determined according to the eye state parameters. If yes, environmental parameters of the user's location are sensed by using a second sensing unit. The eyes state parameters and the environmental parameters are analyzed synthetically, such that the projection display setting of the head-mounted display could be adjusted adaptively.

### CROSS-REFERENCE TO RELATED APPLICATION

This application claims the priority benefit of Taiwan application serial no. 102110950, filed on Mar. 27, 2013. The entirety of the above-mentioned patent application is hereby incorporated by reference herein and made a part of this specification.

### FIELD OF THE INVENTION

The present invention relates to a head-mounted display (HMD), and more particularly, to a method for adjusting the HMD adaptively.

DESCRIPTION OF RELATED ART

The applications of HMDs nowadays mainly use blinking as the mean for controlling image capturing or for determining whether the captured object meet the perfect image standard. With HMDs becoming more compact and with wider view angle, more and more derivative functions are added to the HMDs. Thereby, users increasingly rely on HMDs and the usage duration of the HMDs is prolonged. Therefore, it is necessary to develop a method of adjusting HMDs for the health of user's eyes.

### SUMMARY OF THE INVENTION

The present invention provides a method for adjusting a head-mounted display (HMD) adaptively and a HMD, which reduce the duration and the times for a user's eyes to adapt different environmental brightness, so as to achieve the effect of relief the fatigue of the user's eyes.

A method for adjusting head mounted display adaptively is provided. The method includes the following steps. At least one eye-state parameter of a user wearing the HMD is sensed by a first sensing unit, and whether the eyes of the user are discomfort or not is determined according to the eye-state parameter. If yes, at least one environmental parameter of the user's location is sensed by a second sensing unit. The at least one eye-state parameter and the at least one environmental parameter are analyzed synthetically, so as to adjust at least one projection display setting of the HMD adaptively.

In an embodiment of the present invention, the eye-state parameter of the user includes blinking frequency, eye moistness and bloodshot ratio of eye.

In an embodiment of the present invention, sensing the bloodshot ratio of the eye of the user includes the following steps. A facial image of the user is captured and eye detection is performed to obtain an eye region from the facial image. Also, a color distribution the eye region is analyzed to calculate the bloodshot ratio of the eye after a color space conversion is performed to the eye region. Herein, the bloodshot ratio of in the eye greater than a predetermined value represents the discomfort of the user's eyes.

In an embodiment of the present invention, sensing the eye moistness of the user includes the following steps. A facial image of the user is captured and eye detection is performed to obtain an eye region from the facial image. Also, at least one eye-image feature of the eye region is analyzed and compared with a data base, so as to determine the eye moistness of the user.

In an embodiment of the present invention, sensing the environmental parameter of the user's location includes the following steps. A scene, environmental brightness or environmental color temperature of the user's location is sensed by auto-exposure (AE) algorithm or auto white balance (AWB) algorithm.

In an embodiment of the present invention, adjusting the projection display setting of the HMD adaptively includes the following steps. Projection brightness, icon color, front color or display contrast ratio of the HMD is adjusted according to the change of the environmental brightness, the environmental color temperature and the scene.

In an embodiment of the present invention, the second sensing unit includes a first image capturing device and a second image capturing device, and adjusting the display contrast ratio of the HMD includes the following steps. Firstly, a first image and a second image are respectively taken by the first image capturing device and the second image capturing device. The first image and the second image are synthesized to generate a high dynamic range image suitable for being viewed by the user.

In an embodiment of the invention, the method for adjusting head mounted display adaptively further includes the following steps. Whether a continuous usage duration of the user wearing the HMD is greater than a predetermined usage duration or not is determined. When the continuous usage duration is greater than the predetermined usage duration, the HMD is controlled to generate a notification signal.

In an embodiment of the invention, when the continuous usage duration is greater than the predetermined usage duration, the method further includes controlling the HMD to automatically enter a sleeping mode.

A HMD suitable for being worn on a head of a user is provided. The HMD includes a projection display unit, a first sensing unit, a second sensing unit and a processor. The first sensing unit is configured to sense at least one eye-state parameter of the user. The second sensing unit is configured to sense at least one environmental parameter of the user's location. The processor is coupled to the projection display unit, the first sensing unit and the second sensing unit. The processor determines whether the user's eyes are discomfort or not according to the eye-state parameter. If yes, the processor analyzes the at least one eye-state parameter and the at least one environmental parameter synthetically, so as to adjust at least one projection display setting of the projection display unit adaptively.

Based on the above-mentioned description, the method for adjusting the HMD adaptively and the HMD provided by the invention adjust the projection display settings of the HMD adaptively by synthetically analyzing the eye state of the user and the surrounding environment of the user's location, so as to improve or reduce the fatigue condition of the user resulting from wearing the HMD.

To make the above features and advantages of the present invention more comprehensible, several embodiments accompanied with drawings are described in detail as follows.

### BRIEF DESCRIPTION OF THE DRAWINGS

FIG. 1A is a block diagram of a head-mounted display (HMD) according to an embodiment of the invention.

FIG. 1B is a schematic view of an application scenario of the HMD 100 in FIG. 1A.

FIG. 2 is a flowchart of a method for adjusting a HMD adaptively according to an embodiment of the invention.

FIG. 3 is a schematic view of an application scenario of adjusting icon color and font color according to environmental brightness and environmental color temperature according to an embodiment of the present invention.

FIG. 4 is a schematic view of an application scenario of adjusting icon color and font color according to environmental brightness and environmental color temperature according to another embodiment of the present invention.

FIG. 5 is a schematic view of another application scenario of the HMD 100 in FIG. 1A.

FIG. 6 is a flowchart of a method for adjusting a HMD adaptively according to another embodiment of the invention.

### DESCRIPTION OF EMBODIMENTS

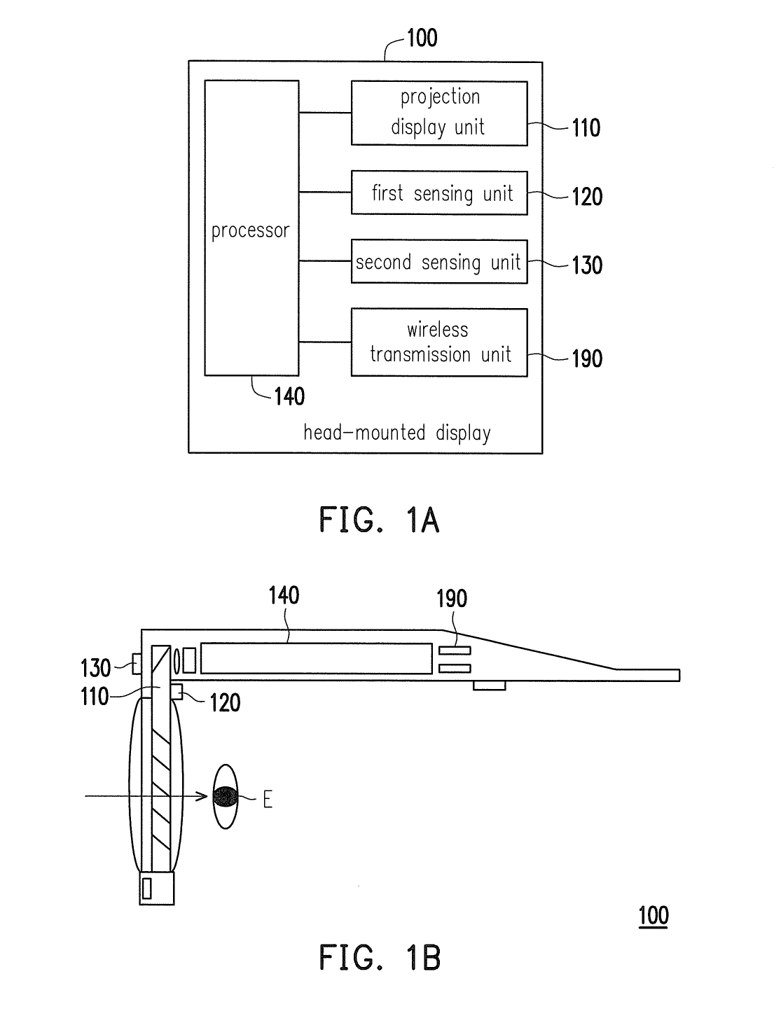

FIG. 1 A illustrates a block diagram of a head-mounted display according to an embodiment of the invention. The head-mounted display (HMD) 100 of the present embodiment is suitable for being worn on a user's head, such that the HMD 100 may provide image information to the user's eyes. Referring to FIG. 1A, the HMD 100 includes a projection display unit 110, a first sensing unit 120, a second sensing unit 130, a processor 140 and a wireless transmission unit 190. The projection display unit 110 may be configured to display image signals. In one embodiment, the projection display unit 110 may further includes a lens, a reflection component, a refraction component, etc. for adjusting the focus thereof The user may see the reality image of the surrounding environment and the virtual image displayed by the projection display unit 110 simultaneously by wearing the HMD 100. That is to say, without influencing the user's day-to-day activities, the user may receive the information such as transportation information, forecast information, schedule notification, incoming-call message, GPS navigator, and time notification, which is not limited herein, in image formation by the HMD 100, such that the user's daily life becomes more convenient.

FIG. 1B is a schematic view of the application scenario of the HMD 100 in FIG. 1A. As shown in FIG. 1B, the first sensing unit 120, for example, faces toward the user's eyes E, for sensing at least one eye-state parameter of the user. The second sensing unit 130, for example, faces toward a scene where the user faces, for sensing at least one environmental parameter of the user's location. In one embodiment, the first and the second sensing units 120, 130 are respectively image capturing devices for capturing images. The processor 140 is, for example, central processing unit (CPU) or other programmable microprocessor, application specific integrated circuit (ASIC), etc., for general purposes or special purposes. The processor 140 may receive the parameters sensed by the first and the second sensing unit 120, 130, so as to adjust at least one projection display setting of the projection display unit 110 adaptively.

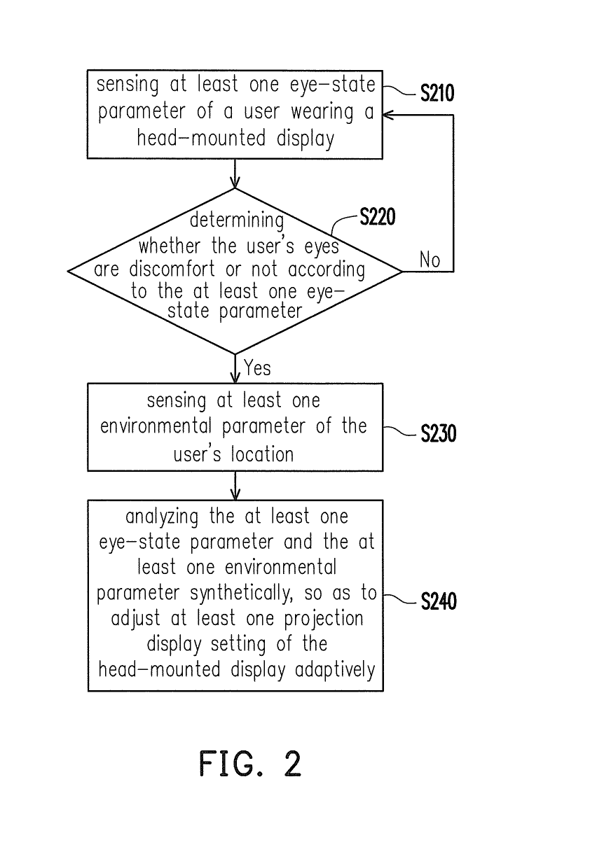

FIG. 2 is a flowchart of a method for adjusting a HMD adaptively according to an embodiment of the invention. The method in the present embodiment is applicable to the HMD 100 in FIG. 1A, and the steps of the method for adjusting the HMD adaptively in the present embodiment are illustrated below along with each of the components of the HMD 100.

Firstly, in step S210, the first sensing unit 120 senses at least one eye-state parameter of the user wearing the HMD 100. Herein, the at least one eye-state parameter, for example, includes blinking frequency, eye moistness and bloodshot ratio of eye, etc., of the user, but the present invention is not limited thereto. As long as the reference indexes used to determine whether the user's eyes are tired or not may be the eye-state parameter of the present embodiment. In step S220, the processor 140 determines whether the user's eyes are discomfort or not according to the eye-state parameter.

For example, the method of the first sensing unit 120 sensing the bloodshot ratio of the eye of the user includes the following steps. Firstly, a facial image of the user is captured and eye detection is performed to obtain an eye region from the facial image. Then, a color space converter, for example, converted into YCbCr image, is performed on the eye region. Next, the processor 140 analyzes a color distribution of the eye region to calculate the bloodshot ratio of the eye. In detail, the processor 140 may predetermined a critical range of target color. When CbCr value of the eye region falls within the critical range of target color, the processor 140 determines the color of the eye region of the user with red tone, and calculates the bloodshot ratio of the eye. The bloodshot ratio of the eye greater than a predetermined value represents the discomfort of the user's eyes. Herein, the critical range of target color and the predetermined value may be set by people skilled in the art, and the present invention is not limited thereto.

For another example, the first sensing unit 120 sensing the eye moistness of the user includes the following steps. Firstly, a facial image of the user is captured and eye detection is performed to obtain an eye region from the facial image. Also, the processor 140 analyzes at least one eye image feature of the eye region and compares with a data base (not illustrated in FIG. 1A), so as to determine the eye moistness of the user. In detail, the data base may perform dataset training in advance, which means recording great amount of images of the eye region with normal eye moistness in advance, and analyzing the same or similar eye image features of the images of the eye region. Thereby, the processor 140 may compare the eye image features captured by the first sensing unit 120 with the database. When the eye moistness of the user is insufficient, the eye image features are different from the eye image features stored in the database. That is to say, when comparison result compared by the processor 140 is not conformable, it represents the discomfort and fatigue of the user's eye.

For another example, the first sensing unit 120 may use, for example, blinking eye detection algorithm to calculate the times the user blinks in a predetermined period, for example, 10-30 seconds, and that is so-called the blinking frequency. Next, the processor 140 determines whether the blinking frequency is greater than a predetermined frequency. If yes, it represents the user blinks excessively and the user's eye may be in discomfort.

Referring back to FIG. 2, if, in step S220, the determination is no, then the procedure returns to step S210, which is the first sensing unit 120 continuously sensing the eye-state parameter of the user wearing the HMD 100. If the determination is yes, then the procedure moves on to step S230, which is the second sensing unit 120 sensing the environmental parameter of the user's location. To be more specific, the second sensing unit 120 may sequentially capturing the images of the surrounding environment of the user's location by auto-exposure (AE) algorithm and/or auto white balance (AWB) algorithm, such that the processor 140 may determine the environmental parameters of the user's location such as indoor scene, outdoor scene, environmental brightness or environmental color temperature, etc. after receive a plurality of images of the surrounding environment.

In step S240, the processor 140 analyzes the eye-state parameters and the environmental parameters synthetically, so as to adjust the projection display settings of the HMD 100 adaptively. In detail, the processor 140 may adjust projection brightness, icon color, front color or display contrast ratio of the HMD according to the change of the environmental brightness, the environmental color temperature and the scene.

In general, to maintain the visibility in a darker environment, the pupils of people's eyes have to be dilated, and need a period of time to adapt the environmental brightness to be able to see images clearly. In contrast, to maintain the visibility in a brighter environment, the pupils of people's eyes have to be constricted, and also need a period of time to adapt the environmental brightness to be able to see images clearly. Therefore, if the processor 140 determines the environmental brightness of the user's location gets darker or the user locates at the indoor scene, the processor 140 may control the projection display unit 110 to increase the projection brightness to a degree that is suitable for being viewed by human's eyes as soon as possible. Similarly, if the processor 140 determines the environmental brightness of the user's location gets brighter or the user locates at the outdoor scene, the processor 140 may control the projection display unit 110 to decrease the projection brightness to a degree that is suitable for being viewed by human's eyes as soon as possible. Thereby, the user's eyes may not feel tired too quickly.

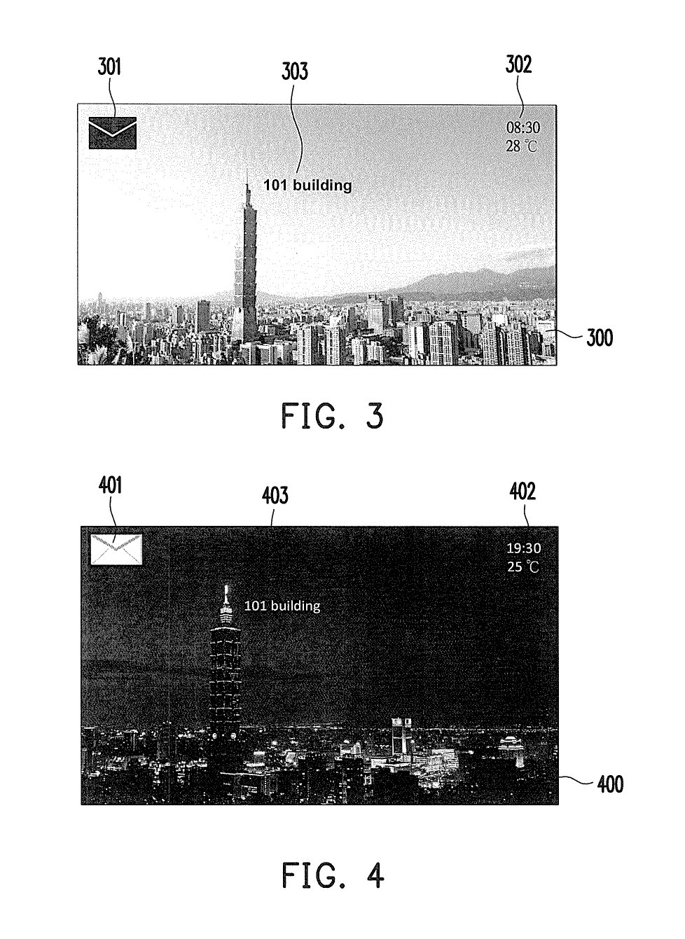

In addition, the processor 140 may also adjust the icon color and the font color displayed by the projection display unit 110 according to the environmental brightness and the environmental color temperature. FIG. 3 is a schematic view of the application scenario of adjusting icon color and font color according to environmental brightness and environmental color temperature according to an embodiment of the present invention. As shown in FIG. 3, when the user locates at the environment with high brightness and high color temperature, the view seen by the user is 300, and the processor 140 may control the projection display unit 110 to adjust the font colors 302, 303 and the icon color 301 to the color with low color temperature and low brightness, so as to avoid the problem of the user unable to see things clearly which increases the burden on the user's eyes. Therefore, the effect of relieving the burden on the user's eye is achieved. FIG. 4 is a schematic view of the application scenario of adjusting icon color and font color according to environmental brightness and environmental color temperature according to another embodiment of the present invention. When the user locates at the environment with low brightness and low color temperature, As shown in FIG. 4, the view seen by the user is 400, and the processor 140 may control the projection display unit 110 to adjust the font colors 402, 403 and the icon color 401 to the color with high color temperature and high brightness (e.g. Light blue), so as to reduce the burden on the user's eyes.

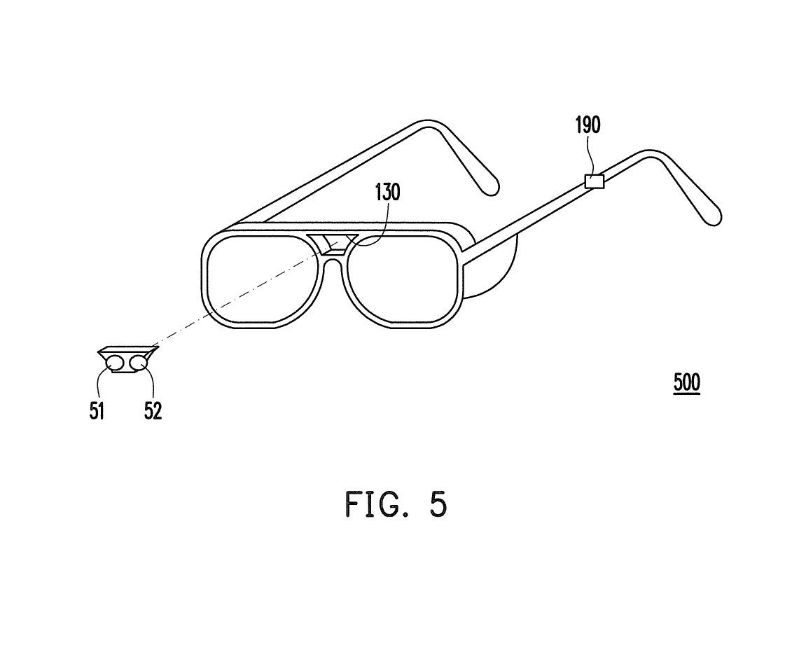

In another embodiment, FIG. 5 is a schematic view of another application scenario of the HMD 100 in FIG. 1A. As shown in FIG. 5, when the second sensing units 130 of the HMD 100 are the first and the second image capturing devices 51, 52, and adjusting the ratio of display contrast of the HMD 100 includes the following steps. Firstly, a first image and a second image are respectively taken by the first and the second image capturing devices 51, 52. Herein, the first image is, for example, captured by long exposure photography, and the second image is, for example, captured by short exposure photography. Thus, synthesizing the first image and the second image may generate a high dynamic range image which is suitable for being viewed by the user. Thereby, the processor 140 may control the projection display unit 110 to display the high dynamic range image, which not only improves the discrimination of the images, but also reduces the duration and the times for a user's eyes to adapt different environmental brightness, so as to achieve the effect of relieving the fatigue of the user's eyes.

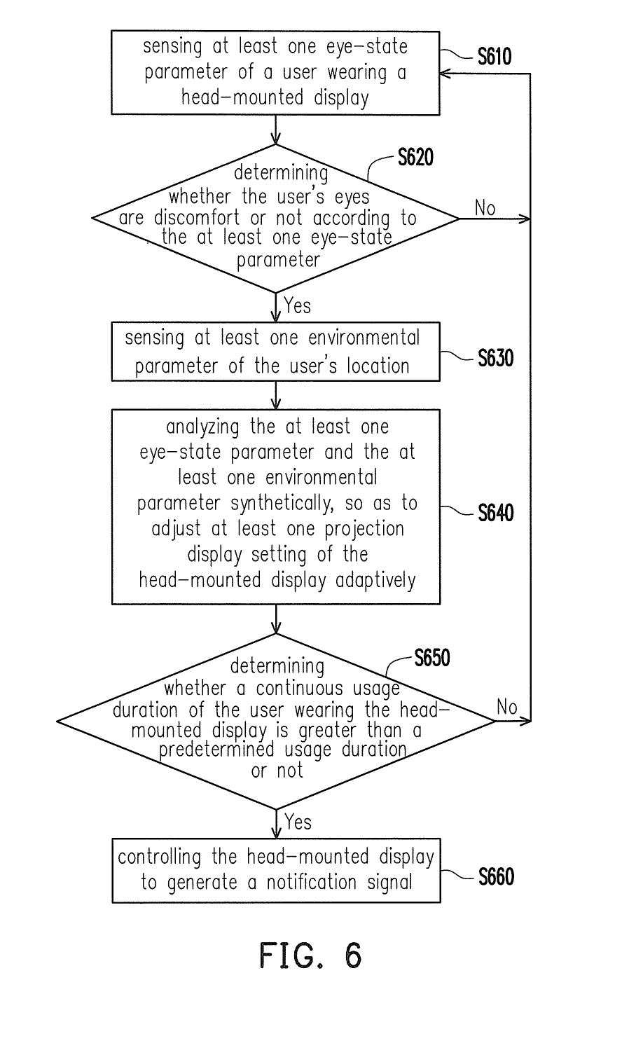

In order to make the invention more comprehensible, embodiments are described below as the examples to prove that the invention can actually be realized. FIG. 6 is a flowchart of a method for adjusting a HMD adaptively according to another embodiment of the invention. The method of the present embodiment is also applicable to the HMD 100 in FIG. 1A.

Referring to FIG. 6, firstly, at least one eye-state parameter of a user wearing the HMD 100 is sensed (step S610). Next, whether the user's eyes are discomfort or not is determined according to the eye-state parameter (step S620). If no, the procedure returns to step S610. If yes, at least one environmental parameter of the user's location is sensed. Also, the eye-state parameter and the environmental parameter are analyzed synthetically, so as to adjust at least one projection display setting of the HMD adaptively (step S640). The detailed content of the above-mentioned steps are all identical or similar to the steps S610-S640 in the previous embodiments, and will not be repeated herein.

However, the fatigue of the user's eyes may still not be improved after the projection display setting of the HMD has been adjusted to the setting suitable for being viewed by the user according to the surrounding environment. The main reason is that the duration of wearing the HMD for the user is excessively long, which leads to fatigue caused by overuse of the user's eyes, and it is not caused by the display settings of the HMD. To overcome such problem, as shown in FIG. 6, whether a continuous usage duration of the user wearing the HMD is greater than a predetermined usage duration is further determined (step S650). For example, the predetermined usage duration is, for example, 2-3 hours. Herein, the predetermined usage duration may be set by manufacturers of the HMD or by the user according to actual situations. When the continuous usage duration is greater than the predetermined usage duration, the HMD is controlled to generate a notification signal notifying the user to take a rest. The notification signal may be the image signal includes text and/or figure. If the HMD is equipped with sound broadcasting device, the notification signal may be, for example, a sound signal, so as to notify the user to stop using the HMD to improve the fatigue condition of the user's eyes. If the user is a child or a teenager, the notification signal may also notify the user's parents or guardians through the wireless transmission unit 190, so as to track the fatigue condition of the user's eyes and the usage duration.

In another embodiment, step S620 of the present embodiment not only determines whether the user's eyes are discomfort, but also categorizes the discomfort of the eyes into a plurality of levels, for example, mild fatigue, moderate fatigue and extreme fatigue, etc. The level of fatigue of the user's eyes is determined by analyzing the eye-state parameter (blinking frequency, eye moistness and bloodshot ratio of eye). If the user still does not takes a rest and the fatigue level of the eyes is extreme fatigue when the continuous usage duration is greater than the predetermined usage duration and after the notification signal is generated, the HMD is controlled to enter the sleeping mode automatically. The method for realizing the present invention is not limited to the above-mentioned description. People skilled in the art may modify the content of the above-mentioned embodiments according to actual requirements.

In sum, the method for adjusting the HMD adaptively and the HMD provided by the invention adjust the projection display settings of the HMD adaptively by synthetically analyzing the eye state of the user and the surrounding environment of the user's location, so as to improve or reduce the fatigue condition of the user resulting from wearing the HMD. Moreover, the HMD may also generate the notification signal for notifying the user to take a rest or automatically enters the sleeping mode according to the continuous usage duration and the eye fatigue level, so as to achieve the function of protecting the user's eyes.

Although the present invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A method for adjusting a head-mounted display adaptively, comprising:
sensing at least one eye-state parameter of a user wearing the head-mounted display by a first sensing unit, and determining whether the user's eyes are discomfort or not according to the eye-state parameter;
if yes, sensing at least one environmental parameter of the user's location by a second sensing unit; and
analyzing the at least one eye-state parameter and the at least one environmental parameter synthetically, so as to adjust at least one projection display setting of the head-mounted display adaptively.

2. The method for adjusting the head-mounted display adaptively as claimed in claim 1, wherein the at least one eye-state parameter of the user comprises blinking frequency, eye moistness and bloodshot ratio of eye.

3. The method for adjusting the head-mounted display adaptively as claimed in claim 2, wherein the step of sensing the bloodshot ratio of the eye of the user comprises:
capturing a facial image of the user and performing eye detection to obtain an eye region from the facial image; and
analyzing a color distribution of the eye region to calculate the bloodshot ratio of the eye after performing a color space conversion to the eye region, wherein the bloodshot ratio of the eye greater than a predetermined value represents the discomfort of the user's eyes.

4. The method for adjusting the head-mounted display adaptively as claimed in claim 2, wherein the step of sensing the eye moistness of the user comprises:
capturing a facial image of the user and performing eye detection to obtain an eye region from the facial image; and
analyzing at least one eye image feature of the eye region and comparing with a data base, so as to determine the eye moistness of the user.

5. The method for adjusting the head-mounted display adaptively as claimed in claim 1, wherein the step of sensing the at least one environmental parameter of the user's location comprises:
sensing a scene, environmental brightness or environmental color temperature of the user's location by auto-exposure algorithm or auto white balance algorithm.

6. The method for adjusting the head-mounted display adaptively as claimed in claim 5, wherein the step of adjusting the projection display setting of the head-mounted display adaptively comprises:
adjusting projection brightness, icon color, front color or display contrast ratio of the head-mounted display according to the change of the environmental brightness, the environmental color temperature and the scene.

7. The method for adjusting the head-mounted display adaptively as claimed in claim 5, wherein the second sensing unit comprises a first image capturing device and a second image capturing device, the step of adjusting the display contrast ratio of the head-mounted display further comprises:
capturing a first image and a second image by the first image capturing device and the second image capturing device respectively, and synthesizing the first image and the second image to generate a high dynamic range image suitable for being viewed by the user.

8. The method for adjusting the head-mounted display adaptively as claimed in claim 1, further comprising:
determining a continuous usage duration of the user wearing the head-mounted display; and
controlling the head-mounted display to generate a notification signal when the continuous usage duration is greater than a predetermined usage duration.

9. The method for adjusting a head-mounted display adaptively as claimed in claim 8, wherein when the continuous usage duration is greater than the predetermined usage duration, the method further comprises:
controlling the head-mounted display to enter a sleeping mode automatically.

10. A head-mounted display, suitable for being worn on a head of a user, comprising:
a projection display unit;
a first sensing unit, configured to sense at least one eye-state parameter of the user;
a second sensing unit, configured to sense at least one environmental parameter of the user's location; and
a processor, coupled to the projection display unit, the first sensing unit and the second sensing unit, the processor determining whether the user's eyes are discomfort or not according to the eye-state parameter, if yes, analyzing the at least one eye-state parameter and the at least one environmental parameter synthetically so as to adjust at least one projection display setting of the projection display unit adaptively.
